(19) United States
(12) Patent Application Publication
(10) Pub. No.: US 2011/0148278 A1
(43) Pub. Date: Jun. 23, 2011

(54) DISPLAY APPARATUS

(75) Inventors: Ryo Ohtomo, Chigasaki-shi (JP); Toshimitsu Kawase, Ebina-shi (JP); Kinya Kamiguchi, Kamakura-shi (JP)

(73) Assignee: CANON KABUSHIKI KAISHA, Tokyo (JP)

(21) Appl. No.: 12/971,925

(22) Filed: Dec. 17, 2010

(30) Foreign Application Priority Data
Dec. 21, 2009 (JP) 2009-289731

(51) Int. Cl. H01J 5/50

(52) U.S. Cl. 313/334

(57) ABSTRACT

A display apparatus includes an electroconductive member contacting with each of an electroconductive film and an electrode. The electroconductive member includes a resilient portion holding the electroconductive film between the relevant resilient portion and a second substrate while maintaining contact with the electroconductive film, and a resilient portion holding the electrode between the relevant resilient portion and the second substrate while maintaining contact with the electrode.

### BACKGROUND OF THE INVENTION

1. Field of the Invention

The present invention relates to a display apparatus, and more particularly to a display apparatus including a first substrate and a second substrate, which are positioned to face each other with a spacing kept therebetween.

2. Description of the Related Art

Japanese Patent Laid-Open No. 2003-092075 discloses an image display apparatus including a vacuum envelope constituted by a rear plate on which electron sources are formed, and a face plate on which image display members including fluorescent materials and acceleration electrodes are formed, both the plates being positioned to face each other. In the structure disclosed in Japanese Patent Laid-Open No. 2003-092075, an independent wiring is provided around a lead line through which a high voltage is applied to the acceleration electrode, and it is led out from the vacuum envelope. A front film including an ITO (Indium Tin Oxide) layer is bonded to a front surface of the face plate. Further, an adhesive surface formed at one end of an electroconductive contact tape is fixed to a lead-out portion of the independent wiring, and an adhesive surface formed at the other end of the electroconductive contact tape is fixed to the front film.

In the known structure, however, reliability in electrical connection degrades between an electroconductive film, such as the contact tape, and an electrode led out from the envelope, such as the independent wiring. Hence, potentials at the electroconductive film, such as the ITO layer, and at the electrode are not reliably held as specified.

### SUMMARY OF THE INVENTION

The present invention provides a display apparatus, which can improve reliability in electrical connection between an electroconductive film and an electrode, and which can ensure stable display for a long period.

According to the present invention, there is provided a display apparatus including an envelope, a display unit, an electroconductive layer, an electroconductive film, an electrode, and an electroconductive member. The envelope includes an insulating first substrate, an insulating second substrate having a surface that is positioned to face the first substrate with a spacing kept therebetween, and a frame disposed between the first substrate and the second substrate and connected to the second substrate in a portion thereof, which is positioned inward of an edge of the surface of the second substrate. The display unit is disposed in an inside of the envelope, which is surrounded by the first substrate, the second substrate, and the frame. The electroconductive layer is disposed on a side of the first substrate oppositely away from the second substrate. The electroconductive film is disposed on the surface of the second substrate between the portion to which the frame is connected and the edge of the surface of the second substrate, the electroconductive film being connected to the electroconductive layer. The electrode is disposed on the surface of the second substrate between the portion to which the frame is connected and the edge of the surface of the second substrate, the electrode extending up to the inside of the envelope. The electroconductive member is contacted with both the electroconductive film and the electrode. The electroconductive member includes a first resilient portion holding the electroconductive film between the first resilient portion and the surface of the second substrate while maintaining contact with the electroconductive film, and a second resilient portion holding the electrode between the second resilient portion and the surface of the second substrate while maintaining contact with the electrode.

With the present invention, since, on the same surface of the second substrate, the first resilient portion of the electroconductive member contacts with the electroconductive film and the second resilient portion of the electroconductive member contacts with the electrode, reliability of electrical connection between the electroconductive film and the electrode is improved and potentials at the electroconductive member connected to the electroconductive film and the electrode can be held satisfactorily as specified. Hence, the display apparatus can be obtained which ensures stable display for a long period.

Further features of the present invention will become apparent from the following description of exemplary embodiments with reference to the attached drawings.

### BRIEF DESCRIPTION OF THE DRAWINGS

FIGS. 1A and 1B are each a schematic view to explain an example of a display panel.

FIGS. 2A and 2B are each a schematic view to explain the example of the display panel.

FIGS. 3A and 3B are each a schematic view to explain an example of a display apparatus.

FIGS. 4A and 4B are each a schematic view to explain the example of the display apparatus.

FIGS. 5A to 5C are each a schematic view to explain an example of an electroconductive member.

### DESCRIPTION OF THE EMBODIMENTS

A display apparatus includes a display panel made up of at least an envelope and a display unit. The display apparatus further includes a drive circuit for driving the display unit in accordance with an image signal (video signal), and a support for supporting the display panel. Usually, the support mounts the drive circuit thereon, and the drive circuit and the support are disposed in a housing.

An example of the display apparatus according to the present invention will be described below with reference to the drawings.

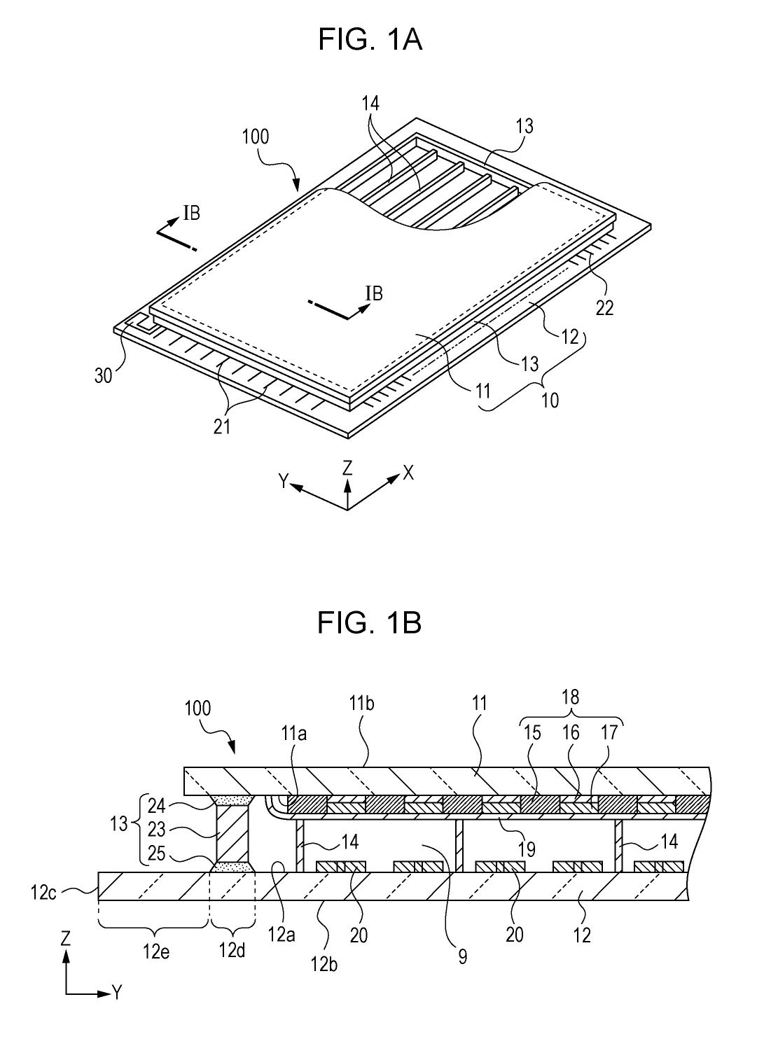

The display panel is described with reference to FIGS. 1A and 1B by taking a display panel 100 for FED (Field Emission Display) as an example of the display panel. FIG. 1A is a schematic perspective view, partly cut away, of the display panel 100, and FIG. 1B is a schematic sectional view taken along a line IB-IB in FIG. 1A.

The display panel 100 includes an envelope 10. The envelope 10 includes an insulating first substrate 11, an insulating second substrate 12, and a frame 13 disposed between the first substrate 11 and the second substrate 12. The first substrate 11 and the second substrate 12 are positioned to face each other with a spacing kept between them. The first substrate 11 has two principal surfaces, i.e., an inner surface 11a as one principal surface and an outer surface 11b as the other principal surface on the side opposite to the inner surface 11a. Also, the second substrate 12 has two principal surfaces, i.e., an inner surface 12a as one principal surface and an outer surface 12b as the other principal surface on the side opposite to the inner surface 12a. The inner surface 11a and the inner surface 12a are positioned to face each other with a spacing kept between them. A surface of the second substrate 12, which is other than the principal surfaces thereof and which is positioned to continuously extend between an edge of the inner surface 12a and an edge of the outer surface 12b, is called an end surface 12c of the second substrate 12.

The frame 13 is connected to each of the first substrate 11 and the second substrate 12. A region surrounded by the first substrate 11, the second substrate 12, and the frame 13 is called an inside 9 of the envelope 10. The inside 9 of the envelope 10 implies a region including an inner surface of the envelope 10. A region on the side opposite to the inside 9 of the envelope 10, which is constituted by the first substrate 11, the second substrate 12, and the frame 13, is called an outside of the envelope 10. The outside of the envelope 10 implies a region including an outer surface of the envelope 10.

The frame 13 is connected to the second substrate 12 at a connecting portion 12d, which is a part of the inner surface 12a of the second substrate 12 and is positioned inward of the edge of the inner surface 12a. A portion of the inner surface 12a, which is positioned between the edge of the inner surface 12a and the connecting portion 12d is called an outer edge portion 12e of the inner surface 12a. The outer edge portion 12e may be exposed to the outside of the envelope 10.

The frame 13 typically includes a frame member 23, a bonding member 24, and a bonding member 25. The first substrate 11 and the frame member 23 are bonded to each other by the bonding member 24. The second substrate 12 and the frame member 23 are bonded to each other by the bonding member 25. The interface between the second substrate 12 and the bonding member 25 is positioned in the connecting portion 12d. The frame member 23 may be dispensed with. In such a case, the frame 13 is formed of a bondable member capable of bonding the first substrate 11 and the second substrate 12 to each other.

An outer edge portion can be defined for the inner surface 11a of the first substrate 11 as with the second substrate 12. Thus, a portion of the inner surface 11a, which is positioned between the edge of the inner surface 11a and a connecting portion between the inner surface 11a and the frame 13 is an outer edge portion of the inner surface 11a. Usually, a width of the outer edge portion of the inner surface 11a is set to be narrower than that of the outer edge portion 12a of the inner surface 12a. As a result, a part of the inner surface 12a, specifically, a part of the outer edge portion 12e, is not positioned to face the inner surface 11a of the first substrate 11.

In the example of FIG. 1B, the first substrate 11 and the second substrate 12 are airtightly bonded to the frame member 23 by the bonding member 24 and the bonding member 25, respectively. As a result, the envelope 10 is constituted as an airtight envelope in which a space between the first substrate 11 and the second substrate 12 is airtightly defined (sealed) by the frame 13 bonded to both the substrates. Further, pressure in the inside of the envelope 10 is held at a level of pressure (vacuum) lower than the atmospheric pressure, whereby the envelope 10 is provided as a vacuum envelope. Many long and thin plate-like spacers 14 are arranged between the second substrate 12 and the first substrate 11 in order to bear the atmospheric pressure acting upon the envelope 10. The foregoing is an outline of the structure of the envelope 10.

The display panel 100 includes, though described in detail later, display units, denoted by reference numerals 15 to 22 in FIGS. 1A and 1B, which are disposed in the inside 9 of the envelope 10.

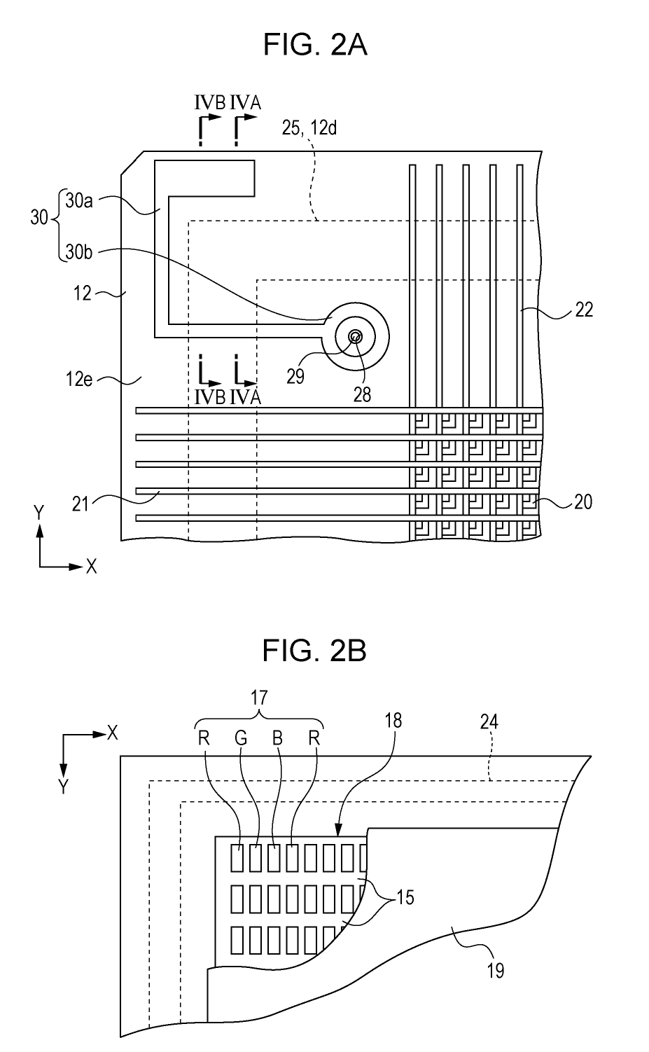

Further, as illustrated in FIG. 1A, the display panel 100 includes an electrode 30. The electrode 30 is described in more detail with reference to FIG. 2A. FIG. 2A is an enlarged view of the electrode 30 and its surroundings in FIG. 1A with the first substrate 11 omitted. The electrode 30 is a continuous electroconductive film formed such that one part 30a of the electrode 30 is disposed in the outer edge portion 12e, and the other part 30b of the electrode 30 is disposed in the inside 9 of the envelope 10. In other words, the electrode 30 is formed to extend from the outer edge portion 12e to the inside 9 of the envelope 10 along the inner surface 12a while passing between the frame 13 and the inner surface 12a. Potentials at components in the inside 9 of the envelope 10 are held as specified by applying a predetermined potential to the electrode 30 outside the envelope 10. The electrode 30 is made of a metal film of copper or silver, and is formed by one of general electrode forming methods, such as a vacuum film formation, e.g., sputtering, and a printing method, e.g., screen printing. A thickness of the electrode 30 is typically 100 μm or less. The term “metal” used in the present invention implies not only a single metal alone, but also an alloy.

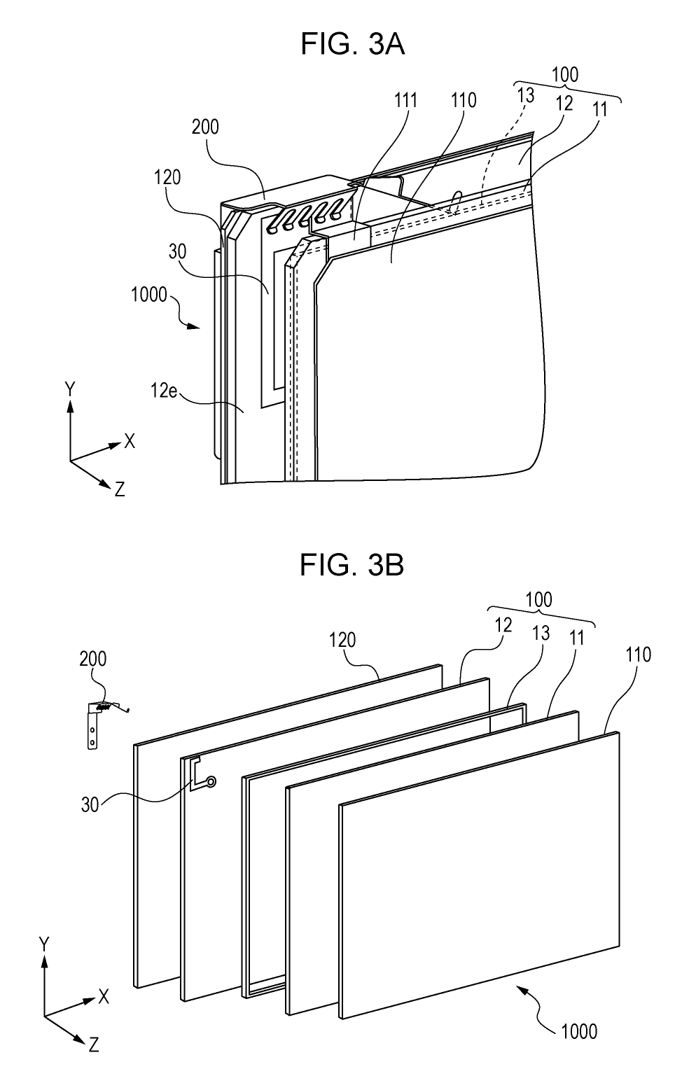

The structure of a display apparatus 1000 will be described below with reference to FIGS. 3A and 3B. FIG. 3A is an enlarged perspective view of a corner of the display panel 100 and its surroundings in the display apparatus 1000, and FIG. 3B is an exploded perspective view of the display apparatus 1000. For simplification of the drawings, the display panel 100 is illustrated as including only the first substrate 11, the second substrate 12, and the frame 13, which constitute the envelope 10, as well as the electrode 30 disposed on the second substrate 12.

As illustrated in FIG. 3A and 3B, the display apparatus 1000 includes an electroconductive layer 110 that is disposed on the front side of the display panel 100, i.e., on the side of the first substrate 11 oppositely away from the second substrate 12. An electroconductive film 111 is electrically connected to the electroconductive layer 110. The electroconductive film 111 is disposed to extend in a direction away from the electroconductive layer 110. A shape of the electroconductive film 111 and a method of forming the same are not limited to particular ones so long as the electroconductive film 111 can exist in a state continuously extending from the outer surface 11b of the first substrate 11 to the inner surface 12a of the second substrate 12 in the structure of the display panel 100. The electroconductive film 111 is preferably made of an electroconductive tape. However, the electroconductive film 111 is not limited to such a slender shape as that of the electroconductive tape, and it may be an electroconductive sheet. Copper is preferably used as the material of the electroconductive film 111. Thus, a copper tape is a preferable example of the electroconductive film 111. The electroconductive tape or sheet may be adhesive. The electroconductive film 111 may be formed, for example, by applying an electroconductive paste in the form of a film by using, e.g., a dispenser, and then drying the paste film. Depending on the material of the electroconductive film 111, the electroconductive layer 110 and the electroconductive film 111 may be integral with each other.

As illustrated in FIG. 3A, the electroconductive film 111 is arranged such that its part is positioned on the outer edge portion 12e of the inner surface 12a of the second substrate 12. On that occasion, the relevant part of the electroconductive film 111 is arranged to make both the electrode 30 and the electroconductive film 111 exposed. Stated another way, the electroconductive film 111 is not arranged such that one of the electrode 30 and the electroconductive film 111 is completely concealed by the other. In the example of FIG. 3A, the electroconductive film 111 is laid over a part of the electrode 30 (as viewed in the Z-direction). On the outer edge portion 12e, the electroconductive film 111 may be overlapped in its part or entirety with the electrode 30. When the electroconductive film 111 and the electrode 30 are overlapped with each other, the electrode 30 is typically positioned on the side closer to the second substrate 12 than the electroconductive film 111. However, the positional relationship between the electrode 30 and the electroconductive film 111 may be reversed. Alternatively, the electroconductive film 111 and the electrode 30 may be arranged side by side on the outer edge portion 12e instead of being overlapped with each other.

The display apparatus 1000 includes an electroconductive member 200. The electroconductive member 200 is just required to have electrical conductivity at least at its surface. Hence, the inside of the electroconductive member 200 may be insulating, but the electroconductive member 200 is preferably made of a metal to obtain a higher level of electrical conductivity. The electroconductive member 200 can be fabricated by pressing a metal plate having a thickness of about 0.1 mm to 1.0 mm. The thickness of the electroconductive member 200 is preferably less than 0.5 mm.

The electroconductive member 200 is preferably made of one of metallic materials having high resiliency, such as copper, aluminum, a copper alloy, an iron alloy, and an aluminum alloy. More preferably, the surface of the electroconductive member 200 is plated so as to provide excellent electrical conductivity and corrosion resistance.

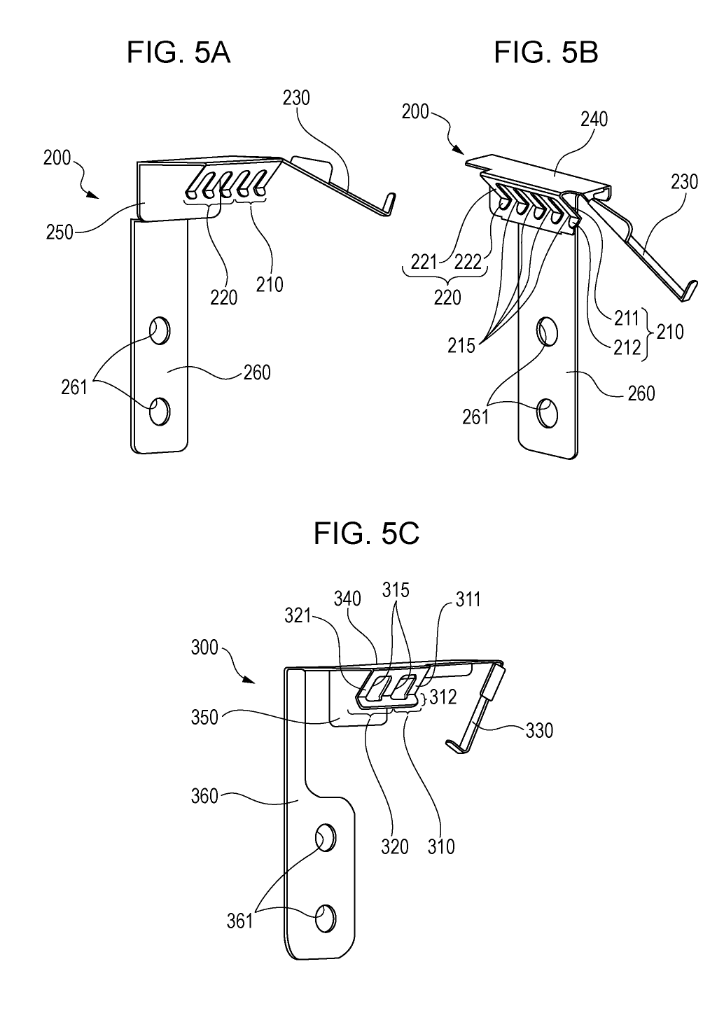

The electroconductive member 200 contacts with each of the electroconductive film 111 and the electrode 30. The electroconductive member 200 is detachably attached to the display apparatus 1000. FIGS. 5A and 5B illustrate an external appearance of the electroconductive member 200 detached from the display apparatus 1000. FIGS. 5A and 5B are external appearance views looking at the same electroconductive member 200 from different directions. Additionally, an electroconductive member 300 illustrated in FIG. 5C is a modification of the electroconductive member.

As illustrated in FIGS. 5A and 5B, the electroconductive member 200 includes a resilient portion 210 (first resilient portion), a resilient portion 220 (second resilient portion), and a resilient portion 230 (third resilient portion). Further, the electroconductive member 200 includes a support portion 240, a confronting portion 250, and a fastened portion 260. The resilient portions 210, 220 and 230 are each connected to the support portion 240 and supported by the support portion 240. The confronting portion 250 is extended from one side of the support portion 240 opposite to the other side thereof to which the resilient portion 210 and the resilient portion 220 are connected. With such an arrangement, the confronting portion 250 is positioned in a confronting (mutually facing) relation to the resilient portion 210 and the resilient portion 220. The fastened portion 260 is extended from the confronting portion 250 in a direction away from the support portion 240. Screw fastening holes 261 are formed in the fastened portion 260. In the example illustrated in FIGS. 5A and 5B, the resilient portion 210 and the resilient portion 220 each have a cantilever structure and have flexibility. A cut (opening) 215 is formed between the resilient portion 210 and the resilient portion 220. Accordingly, the cut 215 serves to restrain the resilient portion 210 and the resilient portion 220 from being deformed in conjunction with each other, and further to allow both the portions 210 and 220 from being deformed independently. Though described in detail later, the resilient portion 230 also has a cantilever structure and is deformable in a direction differing from the direction in which the resilient portion 210 and the resilient portion 220 are deformable. While the resilient portion 230 may be dispensed with, it is preferably disposed when the frame member 23 constituting the frame 13 is electrically conductive.

In the example of FIGS. 5A and 5B, the resilient portion 210 is constituted by two strip-like resilient portions each made up of a beam 211 and a fore end tip 212. The fore end tip 212 is bent relative to the beam 211 such that the resilient portion 210 has a projection. Stated another way, a bent part of the resilient portion 210 forms the projection. Depending on a method of fabricating the electroconductive member 200, a burr may be generated and a small protrusion may be formed near the bent part of the resilient portion 210. Further, in the example of FIGS. 5A and 5B, the resilient portion 220 is constituted by three strip-like resilient portions each made up of a beam 211 and a fore end tip 212. The fore end tip 222 is bent relative to the beam 221 such that the resilient portion 220 has a projection. Stated another way, a bent part of the resilient portion 220 forms a projection. Depending on the method of fabricating the electroconductive member 200, a burr may be generated and a small protrusion may be formed near the bent part of the resilient portion 220. The cut 215 is also formed between adjacent two of the strip-like resilient portions similarly to the position between the resilient portion 210 and the resilient portion 220. It is just required that each of the resilient portion 210 and the resilient portion 220 has at least one strip-like resilient portion. However, the number of strip-like resilient portions is preferably as many as possible.

As illustrated in FIG. 5C, the electroconductive member 300 as a modification of the electroconductive member 200 includes a resilient portion 310 (first resilient portion), a resilient portion 320 (second resilient portion), and a resilient portion 330 (third resilient portion). Further, the electroconductive member 300 includes a support portion 340, a confronting portion 350, and a fastened portion 360. The resilient portions 310, 320 and 330 are each connected to the support portion 340 and supported by the support portion 340. The confronting portion 350 is extended from one side of the support portion 340 opposite to the other side thereof to which the resilient portion 310 and the resilient portion 320 are connected. With such an arrangement, the confronting portion 350 is positioned in a confronting (mutually facing) relation to the resilient portion 310 and the resilient portion 320. Separately from the confronting portion 350, the fastened portion 360 is also extended from the one side of the support portion 340 opposite to the other side thereof to which the resilient portion 310 and the resilient portion 320 are connected. Screw fastening holes 361 are formed in the fastened portion 360. In the electroconductive member 300 as the modification, the resilient portion 310 and the resilient portion 320 each have a cantilever structure and have flexibility. An opening 315 is formed between the resilient portion 310 and the resilient portion 320. Accordingly, the opening 315 serves to restrain the resilient portion 310 and the resilient portion 320 from being deformed in conjunction with each other, and further to allow both the portions 310 and 320 from being deformed independently. An amount of displacement of each resilient portion is set to 0.1 to 1.0 mm in consideration of variation in tolerance.

Though described in detail later, the resilient portion 330 also has a cantilever structure and is deformable in a direction differing from the direction in which the resilient portion 310 and the resilient portion 320 are deformable. While the resilient portion 330 may be dispensed with, it is preferably disposed when the frame member 23 constituting the frame 13 is electrically conductive.

In the example of FIG. 5C, the resilient portion 310 is constituted by one resilient portion having a beam 311. The resilient portion 320 is constituted by two resilient portions each having a beam 321. Further, a fore end tip 312 couples the beam 311 and the beams 321 to each other. The fore end tip 312 is bent relative to the beam 311 and the beams 321 such that the resilient portion 310 and the resilient portion 320 each have a projection. Stated another way, a bent part of each of the resilient portions 310 and 320 forms a projection. Because the opening 315 is formed to position between the beam 311 and the beam 321 and to extend into the fore end tip 312, the projections are easy to deform independently. Depending on the method of fabricating the electroconductive member 300, a burr may be generated and a small protrusion may be caused near the bent part of each of the resilient portions 310 and 320. With the modification described above, while the resilient portions of the electroconductive member 300 are less easy to deform independently than those of the electroconductive member 200, the resiliency of each of the resilient portions 310 and 320 can be increased. Further, because the fore end tip 312 has neither recesses nor projections at its edge, the electroconductive member 200 can be more easily attached to the display panel 100.

An attachment structure of the electroconductive member 200 will be described below. Be it noted that the components of the electroconductive member 300 denoted by the same reference numerals as those of the electroconductive member 200 have similar functions, and hence the description of those components of the electroconductive member 300 is omitted.

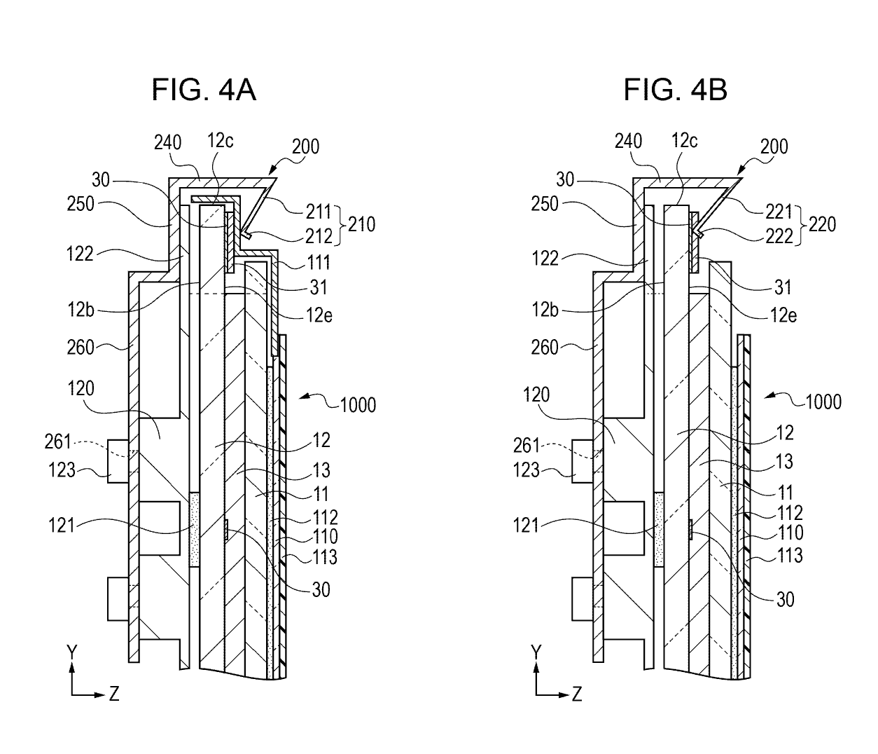

FIGS. 4A and 4B are each a Z-Y sectional view of the display apparatus 1000 illustrated in FIG. 3A. FIGS. 4A and 4B are sectioned at different positions in the X-direction in FIG. 3A. Specifically, the Z-Y sectional view of FIG. 4A includes the resilient portion 210 in a plane of the Z-Y section, and it is a sectional view including a section taken along a one-dot-chain line IVA-IVA in FIG. 2A. Also, the Z-Y sectional view of FIG. 4B includes the resilient portion 220 in a plane of the Z-Y section, and it is a sectional view including a section taken along a two-dot-chain line IVB-IVB in FIG. 2A.

As illustrated in FIG. 4A, the resilient portion 210 contacts (abuts) with the electroconductive film 111 while the electroconductive film 111 is interposed between the resilient portion 210 and the second substrate 12. More specifically, the resilient portion 210 is pressed against the electroconductive film 111 by its own resiliency in the direction toward the second substrate 12 from the electroconductive film 111. As a result, the resilient portion 210 and the electroconductive film 111 contact with each other in a mechanically fixed state, whereby electrical connection (conduction) is established. To describe more exactly, the projection of the resilient portion 210 contacts with the electroconductive film 111. In some cases, the small protrusion formed near the bent part of the resilient portion 210 also contacts with the electroconductive film 111. The contact of the small protrusion with the electroconductive film 111 is preferable from the view point of realizing more stable connection between the electroconductive member 200 and the electroconductive film 111.

As illustrated in FIG. 4B, the resilient portion 220 contacts (abuts) with the electrode 30 while the electrode 30 is interposed between the resilient portion 220 and the second substrate 12. More specifically, the resilient portion 220 is pressed against the electrode 30 by its own resilient force in the direction toward the second substrate 12 from the electrode 30. As a result, the resilient portion 220 and the electrode 30 contact with each other in a mechanically fixed state, whereby electrical connection (conduction) is established. To describe more exactly, the projection of the resilient portion 220 contacts with the electrode 30. In some cases, the small protrusion formed near the bent part of the resilient portion 220 also contacts with the electrode 30. The contact of the small protrusion with the electrode 30 is preferable from the viewpoint of realizing more stable connection between the electroconductive member 200 and the electrode 30.

As described above, the resilient portion 210 and the resilient portion 220 of the electroconductive member 200 are deformable independently. Therefore, the electroconductive member 200 can stably contact (abut) with a plurality of electroconductive films (i.e., the electroconductive film 111 and the electrode 30), which are disposed in the outer edge portion 12e, namely in the same plane (including the inner surface 12a). The advantageous effect of the present invention is particularly significant when the heights of respective surfaces of the electroconductive film 111 and the electrode 30 from the inner surface 12a differ from each other. For example, when the electroconductive film 111 is laid on the electrode 30 as illustrated in FIG. 4A, the height of the surface of the electroconductive film 111 from the inner surface 12a differ from the height of the surface of the electrode 30 from the inner surface 12a. Further, even in the case of the electroconductive film 111 and the electrode 30 being arranged side by side, if the thicknesses of the electroconductive film 111 and the electrode 30 differ from each other, the heights of the surfaces of the electroconductive film 111 and the electrode 30 from the inner surface 12a differ from each other. Stated another way, since the resilient portion 210 and the resilient portion 220 are deformable independently, both the portions 210 and 220 reliably contact with the surfaces of the corresponding electroconductive films regardless of the heights of the surfaces of those electroconductive films from the inner surface 12a, thus ensuring satisfactory electrical connections.

In contrast, if the resilient portion 210 and the resilient portion 220 are not deformable independently, there is a possibility that, although one of the resilient portions 210 and 220 can contact with the corresponding one of the electroconductive film 111 and the electrode 30, the other resilient portion cannot contact with the other of the electroconductive film 111 and the electrode 30, or cannot establish sufficient electrical conduction to it.

The construction of each of the resilient portion 210 and the resilient portion 220 is not limited to the cantilever structure. For example, portions of the electroconductive member 200 coming into contact with the electroconductive film 111 and the electrode 30 may include electroconductive rubber. While the electroconductive rubber may be continuously disposed over those portions coming into contact with the electroconductive film 111 and the electrode 30 by using an integral member, they are preferably disposed in the discontinuous form by using separate members. Further, a coil spring may be used instead of the cantilever structure. However, because the electroconductive rubber generally has higher resistivity than metallic materials, the metallic materials are preferably used for those contact portions in order to establish more satisfactory electrical conduction. Moreover, the cantilever structure is preferable from the viewpoint of facilitating fabrication of the electroconductive member 200, i.e., of manufacturing the electroconductive member 200 by pressing.

The electroconductive member 200 is just required to include at least the resilient portion 210 and the resilient portion 220, and the other portions can be omitted or modified within the scope providing the advantageous effects of the present invention.

A potential at the electroconductive member 200 is held at a predetermined level as specified. Accordingly, the electrode 30, the electroconductive film 111, and the electroconductive layer 110 can be held at substantially the same predetermined potential as specified through the electroconductive member 200. The predetermined potential is preferably the ground potential. The electroconductive member 200 can be brought into resilient contact with the electroconductive film 111 and the electrode 30 by fixing the same to the display panel 100 itself or to a support or a housing (not shown), which is included in the display apparatus 1000. In addition, it becomes easier to hold the above-mentioned components at the ground potential as specified. A preferable example a manner of fixing the electroconductive member 200 is now described. As illustrated in FIGS. 3A and 3B, the display apparatus 1000 includes an electroconductive support 120 on the backside of the display panel 100, i.e., on the side of the second substrate 12 oppositely away from the first substrate 11. The support 120 is a single member or an assembly made up of two or more members and supporting the display panel 100 from the backside of the display panel 100. In the example illustrated in FIGS. 4A and 4B, the support 120 supports the display panel 100 in such a manner that an adhesive member 121 as a part of the support 120 is bonded to the outer surface 12b of the second substrate 12 of the display panel 100. Further, the support 120 may mount an electric circuit board thereon.

The support portion 240 between the resilient portions 210, 220 and the confronting portion 250 of the electroconductive member 200 is positioned to face the end surface 12c of the second substrate 12. Proper positioning of the contact position between the resilient portion 210 and the electroconductive film 111 and the contact position between the resilient portion 220 and the electrode 30 can be performed by abutting the support portion 240 with the end surface 12c when the electroconductive member 200 is attached to the display panel 100. However, it is preferable to leave a gap between the support portion 240 and the end surface 12c and to make fine position adjustment so that the positioning of the above-mentioned contact positions is performed with higher accuracy to be adapted for errors in the size of the second substrate 12 and the respective positions of the electrode 30 and the electroconductive film 111.

A peripheral portion 122 as a part of the support 120 is positioned on the rear side (backside) of the outer edge portion 12e of the second substrate 12, and the confronting portion 250 of the electroconductive member 200 contacts (abuts) with the peripheral portion 122 of the support 120. More specifically, the confronting portion 250 is pressed into contact with the peripheral portion 122. As a result, the confronting portion 250 is fixed to the support 120 and serves as a fulcrum for establishing the contact between the resilient portion 210 and the electroconductive film 111 and the contact between the resilient portion 220 and the electrode 30. Therefore, contact pressure between the resilient portion 210 and the electroconductive film 111 and contact pressure between the resilient portion 220 and the electrode 30 can be increased. While, in FIG. 4A, the electroconductive film 111 is illustrated as extending just to a position facing the end surface 12c of the second substrate 12, the electroconductive film 111 may be extended to a position between the peripheral portion 122 of the support 120 and the confronting portion 250 of the electroconductive member 200. Further, the electroconductive film 111 may be sandwiched between the peripheral portion 122 and the confronting portion 250. With such an arrangement, the number of contacts between the electroconductive film 111 and the electroconductive member 200 is increased and more reliable electrical conduction can be obtained.

As an alternative, when the support 120 is not positioned on the rear side (backside) of the outer edge portion 12e of the second substrate 12, i.e., when the peripheral portion 122 is not present in FIG. 4A, the confronting portion 250 is preferably pressed into contact with the second substrate 12. Even with such an arrangement, the confronting portion 250 can similarly serves as a fulcrum for the resilient portions 210 and 220. Further, the number of contacts between the electroconductive film 111 and the electroconductive member 200 can be increased by extending the electroconductive film 111 so as to lie over the outer surface 12b of the second substrate 12 such that the electroconductive film 111 is sandwiched between the confronting portion 250 and the second substrate 12.

The fastened portion 260 of the electroconductive member 200 is fixedly screwed to the support 120 by using screws 123. When the confronting portion 250 contacts with the support 120, the confronting portion 250 can serve as the fulcrum. On the other hand, when the confronting portion 250 does not contact with the support 120, the fastened portion 260 may serve as the fulcrum. For that reason, when the confronting portion 250 does not contact with the support 120, the fastened portion 260 is required to have sufficient rigidity. A manner of fixing the fastened portion 260 to the support 120 is not limited to the screwing, and other suitable manners, such as fitting and bonding, can also be optionally used.

The support 120 preferably has electrical conductivity. With the support 120 having electrical conductivity, the electroconductive support 120 and the electroconductive member 200 can be held at the same potential through the contact of the support 120 with the confronting portion 250 and/or the fastened portion 260. By using the screws 123, an adhesive, etc., which are electrically conductive, for fixing the fastened portion 260, satisfactory electrical conduction can be obtained. Thus, since a ground terminal of an electrical circuit is usually connected to the support 120, the ground potential can be easily applied to the electroconductive member 200.

As illustrated in FIG. 4B, a protective film 31 for protecting the electrode 30 is preferably disposed to cover the electrode 30. The protective film 31 can protect the electrode 30 from being damaged when the electroconductive member 200 is attached. Further, the protective film 31 can protect the electrode 30 from being degraded (corroded) with, e.g., oxidation that may occur during the manufacturing process of the display panel 100 or due to change over time. The damage and/or the degradation of the electrode 30 may increase a resistance value of the electrode 30. The protective film 31 is a film made of a material differing from that of the electrode 30, and the material of the protective film 31 is not limited to particular one unless the material promotes chemical change of the electrode 30. The protective film 31 may be an insulating film made of, e.g., silicon dioxide. However, the protective film 31 is preferably an electroconductive film in order to more reliably establish electrical conduction between the electrode 30 and the electroconductive member 200. However, because the electroconductive member 200 contacts with the electrode 30 as described below, resistivity of the protective film 31 may be higher that of the electrode 30. From such a point of view, a tantalum nitride (TaN), in particular, can be preferably used as the protective film 31.

After forming the protective film 31 on the electrode 30, the electroconductive member 200 is attached so as to sandwich the electrode 30 and the protective film 31 between the electroconductive member 200 and the second substrate 12, thus pressing the projection of the resilient portions 210 and 220 toward the second substrate 12 against the protective film 31. Accordingly, the projection of the resilient portion 220 is caused to penetrate the protective film 31 and to contact with the electrode 30. Thus, when the small protrusion is formed near the projection of the resilient portion 220, the small protrusion can also be caused to penetrate the protective film 31 and to more reliably contact with the electrode 30. Pressure necessary for causing the projection of the resilient portion 220 to penetrate the protective film 31 can be controlled by changing the width of the projection and the amount of displacement through which the projection is pressed, to thereby adjust a pressing force, depending on the thickness of the protective film 31. For example, when the protective film 31 is a TaN film having a thickness of 100 nm, pressure of 0.2 N or more is required. As an alternative, the contact between the electroconductive member 200 and the electrode 30 may be ensured by selectively removing a part of the protective film 31 where the electroconductive member 200 contacts with the electrode 30, after forming the protective film 31 on the electrode 30.

The resilient portion 230 will be described in below. The resilient portion 230 has a cantilever structure and is connected to the support portion 240. The resilient portion 230 is contacted with the electroconductive frame member 23. More specifically, the resilient portion 230 is pressed against the frame member 23 by its own resiliency in the direction toward the inside 9 of the envelope 10 from the frame member 23. On that occasion, a part of the resilient portion 230 is positioned between the respective outer edge portions of the first substrate 11 and the second substrate 12, but the resilient portion 230 is disposed to be not contacted with the first substrate 11 and the second substrate 12. Because the frame member 23 has a shape surrounding the inside 9 of the envelope 10 and it is electrically conductive, the potential at the periphery of the envelope 10 can be held as specified by the electroconductive member 200. Thus, the resilient portion 230 enables the electrode 30, the electroconductive film 111, the electroconductive layer 110, and the electroconductive frame member 23 to be held substantially at the same predetermined potential as specified through the electroconductive member 200.

To ensure more stable contact, an electroconductive adhesive may be applied to cover the resilient portion 210, the electroconductive film 111, the resilient portion 220, and the electrode 30 such that the resilient portions 210 and 220 are more positively fixed in the state contacting with the electrode 30 and the electroconductive film 111, respectively. An epoxy-based adhesive may be used as the electroconductive adhesive.

The FED-type display panel 100 and display apparatus 1000 will be described in more detail below with reference to FIGS. 1 and 2.

The first substrate 11 and the second substrate 12 can be each formed of a rectangular glass plate. The thickness of each of the first substrate 11 and the second substrate 12 is 0.5 mm to 3 mm and preferably 2 mm or less. The spacing between the first substrate 11 and the second substrate 12 is preferably 200 μm or more to 3 mm or less. A more practicable range of the spacing is 1 mm or more to 2 mm or less. The frame member 23 can be made of, e.g., glass or a metal. When the electroconductive frame member 23 is used, a metal is preferably used. However, an electroconductive coating may be formed substantially over an entire surface of an insulating frame member, which is made of, e.g., glass, because at least the surface of the frame member is just required to have electrical conductivity. The electroconductive frame member 23 can be made of, e.g., aluminum or an iron alloy. Even when a metal is used for the electroconductive frame member, the surface of the frame member is preferably plated with gold or silver, for example, in order to reduce resistance and to suppress oxidation.

The bonding members 24 and 25 can be made of, e.g., glass having a low melting point or a metal having a low melting point. When the envelope 10 is used for the FED, it is constituted as such a vacuum envelope that pressure in the inside 9 of the envelope is held at 10⁻⁴ Pa or lower. Accordingly, the bonding members 24 and 25 are disposed to establish airtight bonding (sealing-off) between the first substrate 11 and the frame member 23 and between the second substrate 12 and the frame member 23. The spacer 14 can be formed of a long and thin glass or ceramic plate. In some cases, the surface of the spacer 14 may be coated with a high-resistance film or may have rugged texture, as required. The height of the spacer 14 in the Z-direction is decided depending on the spacing between the first substrate 11 and the second substrate 12. The spacer 14 is typically disposed in plural, and the interval between two adjacent spacers can be set to 1 mm to 50 mm.

In the inside 9 of the envelope 10, as illustrated in FIG. 1B, a display layer 18 and an anode electrode 19 stacked on the display layer 18 are disposed on the inner surface 11a of the first substrate 11. The display layer 18 includes light-emitting layers 17 each of which is made up of at least light-emitting members. In each of the light-emitting layers 17, as illustrated in FIG. 2B, the light-emitting members emitting beams of light in RGB colors are arrayed in a matrix pattern. The light-emitting members are usually fluorescent members. The light-emitting layer 17 is constituted by a large number of fluorescent member particles. Between adjacent two of the light-emitting layers 17, light-shield layers 15 are disposed which are each typically made of a black material and which are called a “black matrix”.

The display layer 18 may include a color filter layer 16 between the light-emitting layer 17 and the first substrate 11. The anode electrode 19 is positioned in a covering relation to the light-emitting layers 17 as viewed in the Z-axis direction. The anode electrode 19 can be formed of a metal back that is typically made of a metallic material, such as aluminum. When a transparent electroconductive film, such as an ITO film, is used as the anode electrode 19 instead of the metal back, the transparent electroconductive film may be disposed between the light-emitting layers 17 and the first substrate 11.

In the inside 9 of the envelope 10, many electron-emitting devices 20 are arrayed in a matrix pattern on the inner surface 12a of the second substrate 12. Field emission type electron-emitting devices can be used as the electron-emitting devices 20. The field emission type electron-emitting devices may be of the surface conduction type (SCE type), the Spindt type, the CNT type, the MIM type, the MIS type, or the BSD type. A row wiring 21 and a column wiring 22 are connected to each of the many electron-emitting devices 20 arrayed in the matrix pattern. A wiring matrix is constituted by many row wirings 21 and many column wirings 22. A part of each of the many row wirings 21 and the many column wirings 22 is positioned in the inside 9 of the envelope 10, and the other part thereof is led to the outside of the envelope 10 after passing between the second substrate 12 and the frame 13. The row wirings 21 and the column wirings 22 led to the outside of the envelope 10 are disposed on the outer edge portion 12e of the inner surface 12a.

The row wirings 21 and the column wirings 22 led to the outside of the envelope 10 are connected to a drive circuit (not shown) through a flexible printed circuit (FPC) such as a flexible cable, etc. The width of the outer edge portion 12e of the inner surface 12a of the second substrate 12 is typically set to be greater than that of the outer edge portion of the inner surface 11a of the first substrate 11 in order to that the row wirings 21 and the column wirings 22 can be more easily led to the outside of the envelope 10 and connected to the FPC.

Electrons are emitted from the electron-emitting devices 20 by applying a drive voltage to between the row wirings 21 and the column wirings 22 from the drive circuit. Further, an acceleration voltage is generated between the anode electrode 19 and the electron-emitting devices 20 by applying an anode potential of several kV to several tens kV to the anode electrode 19. The electrons accelerated by the acceleration voltage impinge upon the light-emitting layers 17 with energy sufficient to excite the light-emitting members so as to emit light. As a result, the light-emitting layer 17 at a position facing the electron-emitting device 20 emits light (cathode luminescence) to display a full-color image.

The display apparatus 1000 can include, as required, a reception circuit for an information signal, e.g., a television signal, via broadcasting or communication, an information processing circuit for converting an information signal to an image signal, and an image processing circuit for executing predetermined processing on an image signal in conformity with characteristics of the display panel.

A manner of applying the anode potential to the anode electrode 19 is not limited to a particular one. However, the anode potential is preferably applied by using an anode terminal 29 that is electrically connected to the anode electrode 19 at the inside 9 of the envelope 10 via a through-hole 28 formed in the second substrate 12. A gap between the through-hole 28 and the anode terminal 29 is sealed off. Thus, the anode terminal 29 penetrates the second substrate 12. A power supply (not shown) for outputting the anode potential of several kV to several tens kV is connected the anode terminal 29 at a location outside the envelope 10. The anode terminal 29 constitutes a part of the display unit for displaying an image by applying the anode potential to the anode electrode 19.

One example of the electrode 30 will be described below. As described above, the electrode 30 is formed of an electroconductive film and has the function of holding the potentials at the components disposed in the inside 9 of the envelope 10 and thereabout as specified when the predetermined potential is applied to the electrode 30 externally of the envelope 10. When the anode terminal 29 penetrates the second substrate 12, a potential distribution is generated around the anode terminal 29 due to a high potential (anode potential) that is applied to the anode terminal 29. Such a potential distribution may affect the orbit of an electron beam. Further, discharge may occur between the anode terminal 29 and the wirings (i.e., the row wirings 21 and the column wirings 22) and between the anode terminal 29 and the frame 13.

The potential distribution near the anode terminal 29 can be controlled by arranging the electrode 30 at a location in the inside 9 of the envelope 10, which is in the vicinity of the anode terminal 29 and which is properly apart from the anode terminal 29. As illustrated in FIG. 2A, the electrode 30 is preferably arranged in a surrounding relation to the anode terminal 29. Further, the electrode 30 is preferably in the form of a ring continuously surrounding the anode terminal 29 so as to escape a discharge current to the outside of the envelope 10 when discharge is caused between the anode terminal 29 and the electrode 30.

Each of the first substrate 11 and the second substrate 12 constituting the display panel 100 has a rectangular outer shape. The row wirings 21 and the column wirings 22 are led out toward four sides of the second substrate 12. In view of those points, the electrode 30 is preferably disposed at a corner of the second substrate 12. When the display panel 100 has a large size, the electroconductive layer 110 is also required to have a large area. Therefore, the electroconductive film 111 to be connected to the electroconductive layer 110 is preferably connected to the electroconductive layer 110 at plural corners, more preferably at four corners, of the electroconductive layer 110. Stated another way, it is preferable that electrical conduction between the electroconductive member 200 and the electroconductive film 111 is established at plural corners of the second substrate 12. In such a case, the electrode 30 may also be disposed at plural corners, more preferably at four corners, of the second substrate 12 such that the plural electroconductive members 200 are brought into contact with both the electroconductive films 111 and the electrodes 30 at the plural corners in a one-to-one relation. Because the potential distribution at the corner becomes peculiar due to the shape of the corner, reliability is further improved by controlling the potential distributions near the plural corners in the inside 9 of the envelope 10. Additionally, because only one anode terminal 29 described above is needed, the other ones of the electrodes disposed at the plural corners than the electrode 30, which is disposed in a surrounding relation to the anode terminal 29, do not surround the anode terminal 29. The portion 30b of each of the electrodes 30 disposed in the other three corners, which are positioned at the inside 9 of the envelope 10, can be formed in an arbitrary shape.

In the example of FIGS. 4A and 4B, the electroconductive layer 110 is fixed to the outer surface 11b of the first substrate 11 by using an adhesive layer 112. Although an insulating protective layer 113 is disposed on the front side of the electroconductive layer 110 (i.e., on the side thereof oppositely away from the adhesive layer 112) in the example of FIGS. 4A and 4B, the protective layer 113 may be dispensed with. The electroconductive layer 110 can suppress charging on the outer surface 11b of the first substrate 11. Further, the electroconductive layer 110 disposed at the front of the display panel 100 can provide a shield against electromagnetic waves. The function of the electroconductive layer 110 is not particularly limited. From the viewpoint of providing an effect of suppressing the charging, the electroconductive layer 110 is not required to have electrical conductivity at a so high level, and sheet resistance of the electroconductive layer 110 may be about 10⁷ to 10⁹Ω/□ (unit square). The electroconductive layer 110, the adhesive layer 112, and the protective layer 113, which are disposed at the front of the display panel 100, have sufficient optical transparency so that an image displayed by the display panel 100 can be recognized. A transparent electroconductive material, such as ITO or ATO (Antimony Tin Oxide), can be used as the electroconductive layer 110 having sufficient optical transparency. A total thickness of the adhesive layer 112, the electroconductive layer 110, and the protective layer 113 is preferably about 0.2 to 0.4 mm. The electroconductive layer 110 may be formed directly on the outer surface 11b of the first substrate 11 by omitting the adhesive layer 112. Further, the electroconductive layer 110 may be disposed with a gap left between the electroconductive layer 110 and the first substrate 11. In such a case, for example, a transparent plate (not shown) including the electroconductive layer 110 formed thereon is disposed at the front of the display panel 100 in a state apart from the first substrate 11, and the electroconductive film 111 is connected to the electroconductive layer 110 on the transparent plate.

While the description has been made, for example, in connection with the FED which includes the electron-emitting devices in the display unit and which utilizes cathode luminescence, the display unit may utilize other luminescence than the cathode luminescence. As another example, the display unit may be an organic electroluminescence display which includes organic electroluminescence elements and which utilizes electroluminescence, or a PDP (Plasma Display Panel) which includes gas discharge elements and which utilizes photoluminescence. Alternatively, the display unit may be an LCD including liquid crystal elements. However, the advantageous effect obtained by applying the present invention to the FED is more significant for the reason that the FED is more adversely affected by the potential distribution because the FED employs a high voltage (anode potential) and handles electron beams.

### EXAMPLES

Practical EXAMPLES will be described below.

### Example 1

The envelope 10 is constructed of the first substrate 11, the second substrate 12, and the frame member 23, which surround the inside 9 of the envelope 10. Details of the envelope 10 are basically the same as those described above with reference to FIG. 1. The frame 13 has a diagonal length of 55 inches. Each of the first substrate 11 and the second substrate 12 has a thickness of 1.8 mm. The spacing between the first substrate 11 and the second substrate 12 is 1.6 mm.

The second substrate 12 includes the electrode 30 formed thereon to extend up to the inside 9 of the envelope 10. The electrode 30 is made of copper and has a thickness of about 3 μm. The protective film 31 made of TaN is formed in a thickness of 100 nm so as to cover the electrode 30. Surface conduction electron-emitting devices are used as the electron-emitting devices 20. The electron-emitting devices 20 are connected to the row wirings 21 and the column wirings 22 each of which is formed by baking an electroconductive paste containing silver particles.

The envelope 10 having a flat rectangular shape is sealed off under vacuum, and the inside 9 of the envelope 10 is held at pressure of 1.0×10⁻⁵ Pa. The frame member 23 is formed by plating an iron alloy with gold, and indium is used as the bonding members 24 and 25. The bonding between the first substrate 11 and the second substrate 12 is performed by pressing the second substrate 12 against the first substrate 11 in a vacuum chamber while the bonding members 24 and 25 are locally heated. The plurality of spacers 14 in the form of long and thin plates are arranged to extend in the same direction as the lengthwise direction of the envelope 10 having the flat rectangular shape. Further, the plurality of spacers 14 in the form of long and thin plates are arranged at intervals of 15 mm in the widthwise direction of the envelope 10 perpendicular to the lengthwise direction thereof. Each of the spacers 14 is made of glass and has a thickness of 200 μm. The spacers 14 are disposed to lie on the row wirings 21 and are each fixed at opposite ends in the lengthwise direction thereof to the second substrate 12 by using an inorganic adhesive (“ARON CERAMIC D” made by TOAGOSEI CO., LTD.).

A charging suppression film is bonded to the outer surface 11b of the first substrate 11 of the display panel 100. The charging suppression film is constituted by the protective layer 113 made up of a resin, the electroconductive layer 110 disposed on the protective layer 113 and made of ATO, and the adhesive layer 112 disposed on the electroconductive layer 110.

The adhesive layer 112 is bonded to the outer surface 11b of the first substrate 11 in such a state that a copper tape having a thickness of 100 μm is sandwiched as the electroconductive film 111 between a corner of the charging suppression film and a corresponding corner of the first substrate 11.

The support 120 is bonded to the display panel 100. The support 120 is formed of a zinc-electroplated steel plate that has a thickness of 0.8 mm at a position where the fastened portion 260 of the electroconductive member 200 is fixed to the support 120. The support 120 fixed to the outer surface 12b of the second substrate 12 is held at the ground potential as specified.

The electroconductive member 200 is fabricated by pressing a plate made of phosphor bronze and having a thickness of 0.2 mm into the shape illustrated in FIGS. 5A and 5B, and then plating it with nickel.

The electroconductive member 200 has a bifurcated shape including five strip-like cantilever beams. Each of the beams 211 and 221 of the resilient portion 210 and the resilient portion 220 has a width of 1.5 mm and a length of 5 mm. An amount by which each beam is displaced upon pressing is set to 0.5 mm in terms of design value. In consideration of variation in tolerance, however, the amount of displacement is 0.1 to 1.0 mm. Thus, the pressing force per cantilever beam is 1.2 N in terms of design value and the pressing force of 0.2 N or more is obtained.

The resilient portion 230 has a width of 1.2 mm, and the length from the support portion 240 to a position where the resilient portion 230 contacts with the frame member 23 is set to 20 mm. An amount by which the resilient portion 230 is displaced upon pressing is set to 2 mm in terms of design value. In consideration of variation in tolerance, however, the amount of displacement is 0.6 to 3.4 mm. Thus, the pressing force of about 0.1 N to 0.5 N is obtained.

The electroconductive member 200 is mounted to hold (grip) the second substrate 12 and the support 120 from both the sides. As a result, the electroconductive film 111 and the resilient portion 210 are contacted with each other, and the electrode 30 and the resilient portion 220 are contacted with each other. Further, the frame member 23 and the resilient portion 220 are contacted with each other. Because each of the resilient portions 210, 220 and 230 has the cantilever structure, they are pressed respectively against the electroconductive film 111, the electrode 30, and the frame member 23. In addition, because the protective film 31 on the electrode 30 has a thickness of 100 nm, the electroconductive member 200 is caused to penetrate the protective film 31 and to contact with the electrode 30 when it is pressed against the protective film 31 by the pressing force of 0.2 N or more.

The electroconductive member 200 has the screw fastening holes 261 through which the electroconductive member 200 is fixed to the support 120 by using the screws 123 for establishing electrical conduction to the support 120. As a result, even when the display panel 100 is subjected to changes of external environments, such as vibrations and temperature changes, the contact of the electroconductive member 200 with the electroconductive film 111, the electrode 30, and the frame member 23 is not loosened or lost and the latter three components can be reliably held at the same potential (ground potential).

In EXAMPLE 1 having the above-described structure, whether the resistance between the support 120 and each contact point was low or not was confirmed by measurement. The measurement result showed that the resistance between the support 120 and each contact point was low, i.e., 0.1Ω or less. Further, as a result of driving the display panel, any abnormal discharge phenomenon was not confirmed. In addition, any abnormal discharge phenomenon was not confirmed even after carrying out a temperature cycle test of repeating a low temperature and a high temperature in the environment condition for accelerated evaluation. Thus, no occurrence of a contact failure was determined.

### EXAMPLE 2

EXAMPLE 2 differs from EXAMPLE 1 just in that the electroconductive member 200 used in EXAMPLE 1 is replaced with the electroconductive member 300 illustrated in FIG. 5C. Hence, the description of the display apparatus is omitted.

The electroconductive member 300 is fabricated by pressing a plate made of phosphor bronze and having a thickness of 0.2 mm into the shape illustrated in FIGS. 5C, and then plating it with nickel.

Each of the beams 311 and 321 of the resilient portions 310 and 320 has a width of 1.5 mm and a length of 5 mm. An amount by which each beam is displaced upon pressing is set to 0.6 mm in terms of design value. In consideration of variation in tolerance, however, the amount of displacement is 0.3 to 1.1 mm. Thus, the pressing force per cantilever beam is 2.5 N in terms of design value and the pressing force of 1.2 N or more is obtained.

Because the protective film 31 on the electrode 30 has a thickness of 100 nm, the electroconductive member 300 is caused to penetrate the protective film 31 and to contact with the electrode 30 when it is pressed against the protective film 31 by the pressing force of 1.2 N or more. Further, because the pressing force of 1.2 N or more is obtained, positive contact is ensured regardless of the difference in level between the electrode 30 and the electroconductive film 111.

The resilient portion 330 has a width of 1.2 mm, and the length from the support portion 340 to a position where the resilient portion 330 contacts with the frame member 23 is set to 12 mm. An amount by which the resilient portion 330 is displaced upon pressing is set to 3.2 mm in terms of design value. In consideration of variation in tolerance, however, the amount of displacement is 1.6 to 4.8 mm. Thus, the pressing force of about 0.8 N to 3.1 N is obtained.

Also in EXAMPLE 2, whether the resistance between the support 120 and each contact point was low or not was confirmed by measurement. The measurement result showed that the resistance between the support 120 and each contact point was low, i.e., 0.1Ω or less. Further, any abnormal discharge phenomenon was not confirmed even after carrying out a temperature cycle test of repeating a low temperature and a high temperature in the environment condition for accelerated evaluation. Thus, no occurrence of a contact failure was determined.

According to the present invention, as described above, the electroconductive layer and the electrode can be reliably and simply held at the same potential as specified. Therefore, the display apparatus is obtained which can ensure stable display for a long period.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-289731, filed Dec. 21, 2009, which is hereby incorporated by reference herein in its entirety.

What is claimed is:

1. A display apparatus comprising:
an envelope including an insulating first substrate, an insulating second substrate having a surface that is positioned to face the first substrate with a spacing kept therebetween, and a frame disposed between the first substrate and the second substrate and connected to a portion of the second substrate, which portion is positioned inward of an edge of the surface of the second substrate;
a display unit disposed in an inside of the envelope, wherein the display unit is surrounded by the first substrate, the second substrate, and the frame;
an electroconductive layer disposed on a side of the first substrate oppositely away from the second substrate;
an electroconductive film disposed on the surface of the second substrate between the portion to which the frame is connected and the edge of the surface of the second substrate, the electroconductive film being connected to the electroconductive layer;
an electrode disposed on the surface of the second substrate between the portion to which the frame is connected and the edge of the surface of the second substrate, the electrode extending up to the inside of the envelope; and
an electroconductive member contacting both the electroconductive film and the electrode,
wherein the electroconductive member includes a first resilient portion holding the electroconductive film between the first resilient portion and the surface of the second substrate while maintaining contact with the electroconductive film, and a second resilient portion holding the electrode between the second resilient portion and the surface of the second substrate while maintaining contact with the electrode.

2. The display apparatus according to claim 1, wherein each of the first resilient portion and the second resilient portion has a cantilever structure, and wherein a cut or an opening is formed between the first resilient portion and the second resilient portion.

3. The display apparatus according to claim 1, wherein the second resilient portion has a projection contacting with the electrode, and wherein the electrode is covered with a protective film made of a material differing from a material of the electrode.

4. The display apparatus according to claim 1, wherein the frame includes an electroconductive frame member, and the electroconductive member includes a third resilient portion having a cantilever structure, the third resilient portion being contacted with the frame member.

5. The display apparatus according to claim 1, further comprising an electroconductive support configured to support the envelope and disposed on a side of the second substrate oppositely away from the first substrate, wherein the electroconductive member is fixed to the support.

6. The display apparatus according to claim 1, wherein the display unit includes:
electron-emitting devices disposed on the surface of the second substrate;
wirings electrically connected to the electron-emitting devices and led out to an area between the portion of the surface of the second substrate, to which the frame is connected, and the edge of the surface of the second substrate;
a light-emitting layer and an anode electrode, both of which are disposed on a surface of the first substrate positioned to face the surface of the second substrate; and
an anode terminal penetrating the second substrate and connected to the anode electrode in the inside of the envelope,
wherein the electrode is disposed apart from the anode terminal in a surrounding relation to the anode terminal in the inside of the envelope.

7. The display apparatus according to claim 1, wherein the electroconductive member is held at a predetermined potential.

8. The display apparatus according to claim 3, wherein each of the first resilient portion and the second resilient portion has a cantilever structure, and a cut or an opening is formed between the first resilient portion and the second resilient portion.

9. The display apparatus according to claim 4, wherein the second resilient portion has a projection contacting with the electrode, and the electrode is covered with a protective film made of a material differing from a material of the electrode.

10. The display apparatus according to claim 2, wherein the frame includes an electroconductive frame member, and the electroconductive member includes a third resilient portion having a cantilever structure, the third resilient portion being contacted with the frame member.
